(19) United States
(12) Patent Application Publication
(10) Pub. No.: US 2005/0069693 A1
(43) Pub. Date: Mar. 31, 2005

(54) Material for production of junctions between two objects

(76) Inventor: Karl-Heinz Hofmann, 35325 Mucke (DE)

Correspondence Address: Nils H Ljungman & Associates, PO Box 130, Greensburg, PA, 15601-0130, US

(21) Appl. No.: 10/496,579

(22) PCT Filed: Oct. 24, 2002
(86) PCT No.: PCT/EP02/11871

(30) Foreign Application Priority Data
Nov. 22, 2001 (DE) 101-57-286.7

(51) Int. Cl. B32B 7/12

(52) U.S. Cl. 428/317.7

(57) ABSTRACT

The invention relates to a material for the formation of connections between two objects, for example between a roofing tile and a ridge tile. This material is a deformable filter foam, which is impregnated with a substance which is cured when exposed to air. Before the connection is formed, the filter foam with the substance impregnating it, is sealed airtight. When the connection is to be formed, the airtight seal is removed and the substance introduced between the objects to be connected. Due to the exposure to air, which is now possible, the substance becomes cured. This lends the previously soft filter foam a solid structure.

The invention relates to a material for forming connections between two objects, for example between a roofing tile and a ridge tile, according to the preamble of patent claim 1.

A ridge ventilation element is already known, which is fastened at a spacing on the ridge batten of a roof covered with roofing tile plates and which covers with a soft foamed material strip, disposed on its longitudinal sides, the construction gap between the ridge batten and the topside of the adjacent roofing plates (DE 41 23 313 A1). Along each longitudinal side of the ridge ventilation element the soft foamed material strip is fastened on the side facing away from the weather side, which, in cross section, forms an obtuse angle, whose short shank is connected with the longitudinal sides and whose longer shank covers over the adjacent roofing plates and, together with the foamed materials trip, seals the construction gap.

The known ridge ventilation element is clamped on the ridge batten, i.e. the ridge batten is a necessary fastening element for the ridge ventilation element. Consequently, a substructure with ridge batten is necessary in order to fasten the ridge ventilation elements and the ridge tiles.

Moreover, a foamed material shaped body is known, which is comprised of soft-elastic, open-pored synthetic foamed material and which is employed for sealing ridge and crest tiles on building roofs (DE 43 43 059 A1). To increase the resistance of this foamed material shaped body against weathering effects and ultraviolet radiation, the foamed material shaped body is coated at least on an exposed surface with a protective skin of a synthetic material resistant against UV radiation.

The foamed material shaped body is connected with a support element, which rests in contact on a ridge beam.

Foamed synthetic material is also provided in the case of another sealing strip for ridge and/or crest coverings (EP 0 707 120 A1). This sealing strip rests with its center region on a ridge board and with its margin regions on roofing plates. Between center and margin regions open-pored ventilation regions are disposed.

In the case of a known sealing member for a ventilator flap for the rear aeration of roofs in the ridge, hip or crest region, a sealing member body of foamed material is provided, which is developed approximately wedge-form (DE 44 05 201 A1). This sealing member body is connected with the ventilator flap, which, in turn, rests on a ridge batten.

In addition, a covering strip for a ridge or a crest is known, which comprises a center region to be fastened on a ridge or crest batten and which is provided with side strips, which allow air to penetrate through (DE 43 43 000 A1l). The base body of the covering strip comprises here a foamed synthetic material with air penetration openings. The center region is placed on the ridge batten.

All foamed material bodies described above are connected directly or indirectly with a ridge batten or a ridge beam.

U.S. Pat. Nos. 5,362,342, 5,895,536, 5,951,796 disclose connecting roofing tiles with roof components or with other roofing plates by means of urethane foam or by means of a one- or two-component adhesive agent. However, the problem of ridge sealing and ventilation is not addressed.

Furthermore, a ridge sealing and fastening system is also known in which a polyurethane adhesive foam is introduced into a space between adjacent roofing plates along the ridge (U.S. Pat. No. 6,164,021). Hereby the space between adjacent roofing plates is filled. When applied for a second time, the polyurethane adhesive foam generates an adhesive connection between the lower surface of a ridge tile and the adjacent roofing plates.

Known is also a roof ridge and crest sealing formed component which is comprised of a compressible and flexible flat body, which includes at its upper side a pin molding in integral connection (DE 77 35 419 U1). The compressible and flexible flat body is comprised of foamed material provided with an impregnation based on polyacrylate.

In another known sealing strip for ridge and crest coverings a dimensionally stable, open-celled and air-impermeable soft foam is provided, which is a hydrolysis-resistant polyether foam provided with UV stabilizers (DE 39 05 142 C2).

Lastly, a foamed material body for covering ridges and crests of building roofs is also known, which is comprised of a filter foamed material having the structure of a three-dimensional wire lattice (DE 39 05141 A1).

The invention addresses the problem of providing a material with which two objects can be connected such that between them ventilation takes place.

This problem is solved according to the characteristics of patent claim 1.

The invention thus relates to a material for forming connections between objects, for example between a roofing tile and a ridge tile. This material is a deformable filter foam impregnated with a substance which cures when exposed to air. Before forming the connection, the filter foam, together with the substance with which it is impregnated, is sealed airtight. When the connection is to be formed, the airtight seal is removed and the foam including the substance is introduced between the objects to be connected. Through the admission of air, which is now possible, the substance is cured. This lends a solid structure to the previously soft filter foam.

One advantage attained with the invention lies therein that a ridge ventilation and fastening system can be provided, in the case of which a substructure with ridge batten holders and ridge battens becomes superfluous. In addition, the mortar connection of ridge tiles and roofing tiles, common in Southern Europe, can be omitted.

Embodiment examples of the invention are depicted in the drawing and will be described in further detail in the following. In the drawing show:

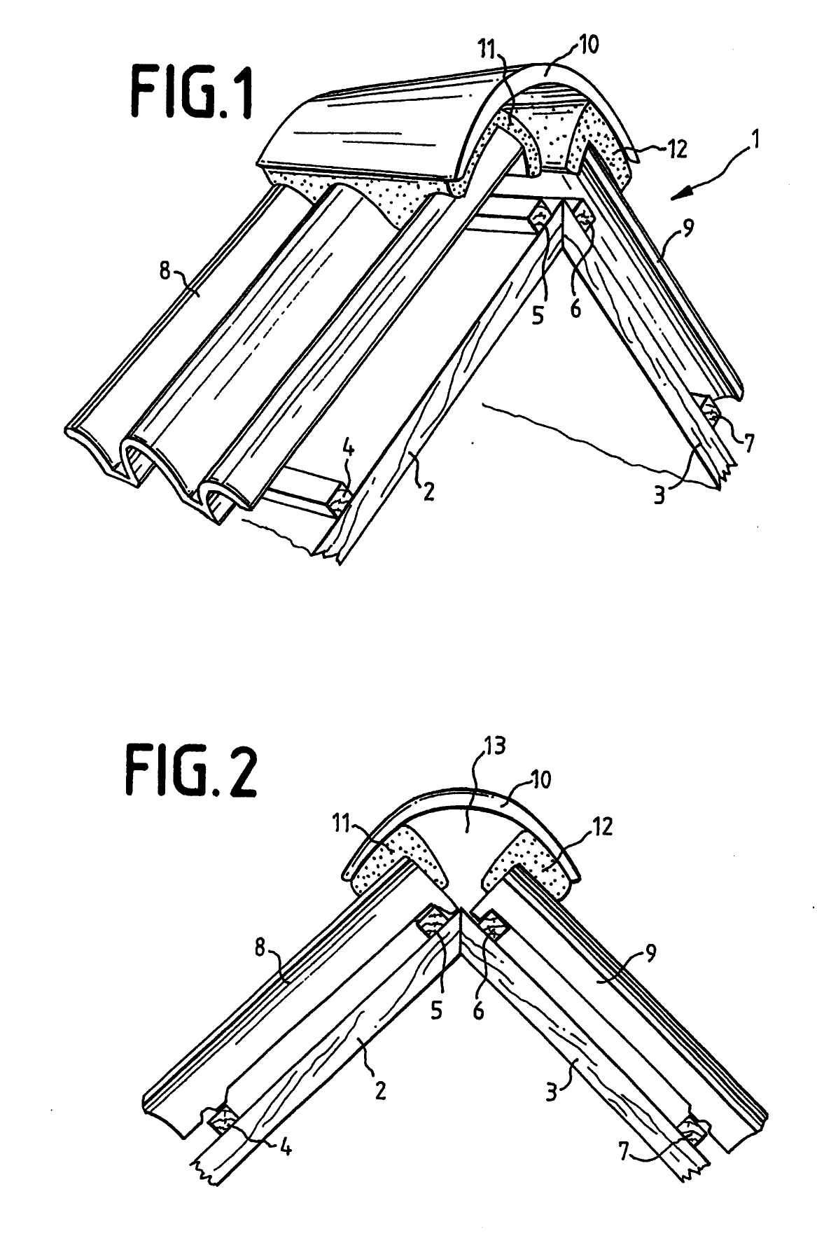

FIG. 1 perspective representation of a portion of a roof ridge with a connection according to the invention between a ridge tile and roofing tiles,

FIG. 2 front view of the portion of the roof ridge shown in FIG. 1,

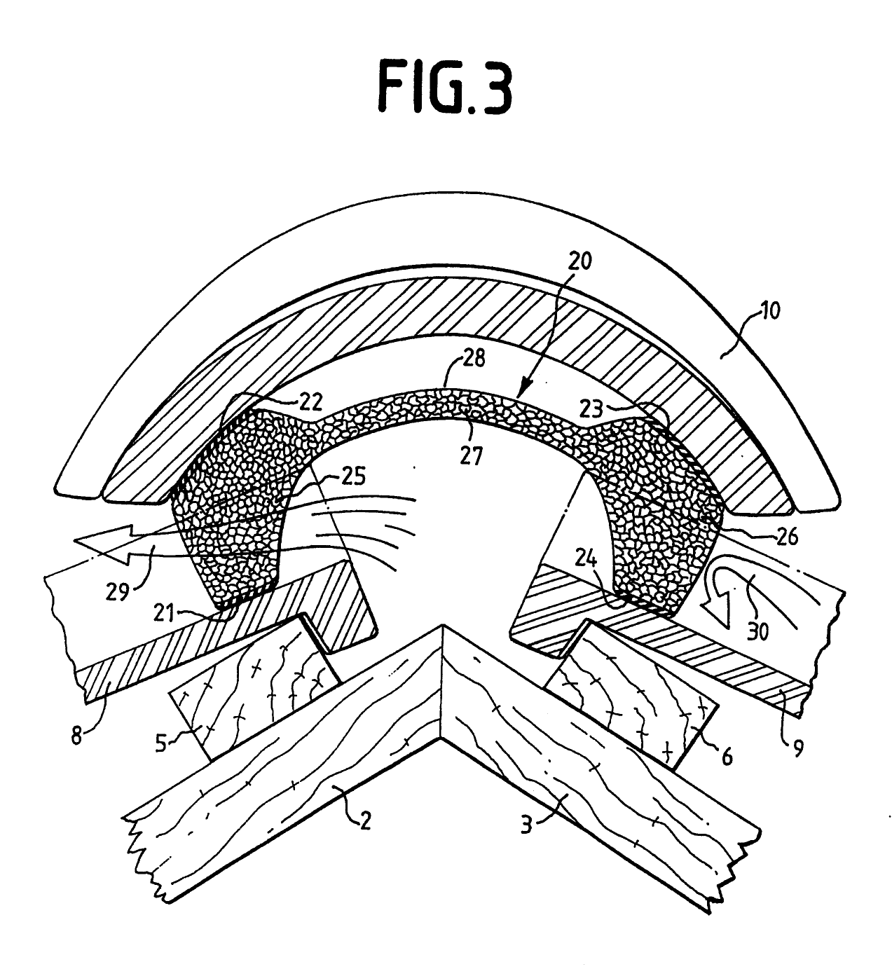

FIG. 3 front view of a section through a roof ridge, with a variant of a connection material between ridge tile and roofing tiles being shown,

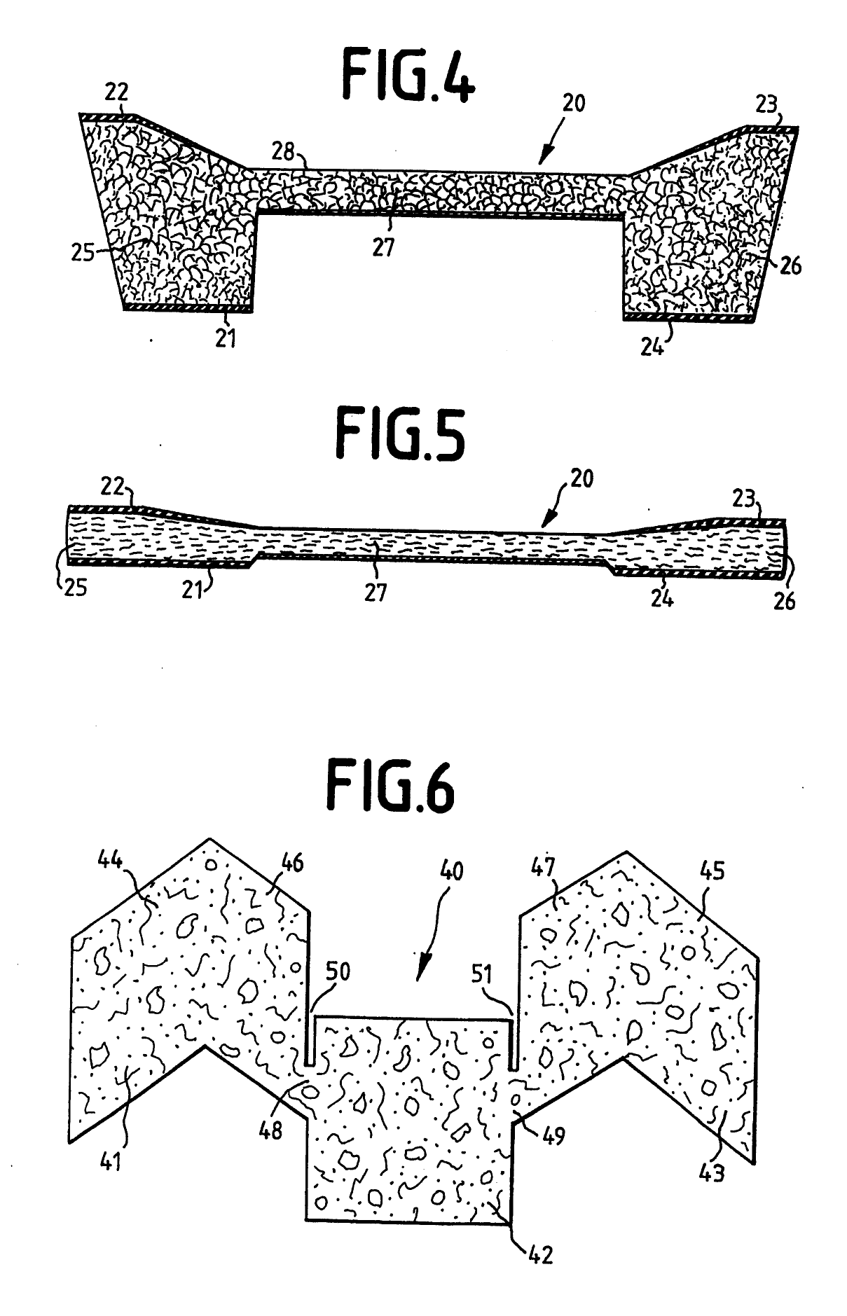

FIG. 4 isolated representation of the connection material depicted in FIG. 3 before the installation between window and roofing tile,

FIG. 5 the connection material shown in FIG. 4 in compressed form,

FIG. 6 an alternative embodiment of the connection material,

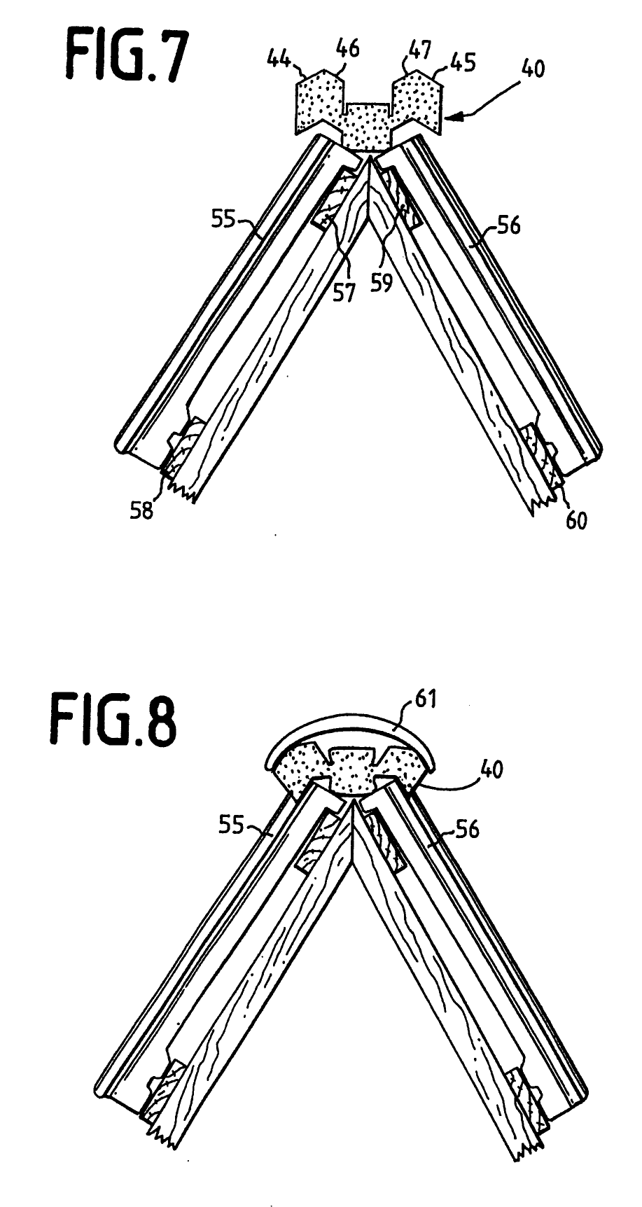

FIG. 7 application of the connection material according to FIG. 6 in a roof ridge,

FIG. 8 the roof ridge according to FIG. 7, however, with the ridge tile emplaced,

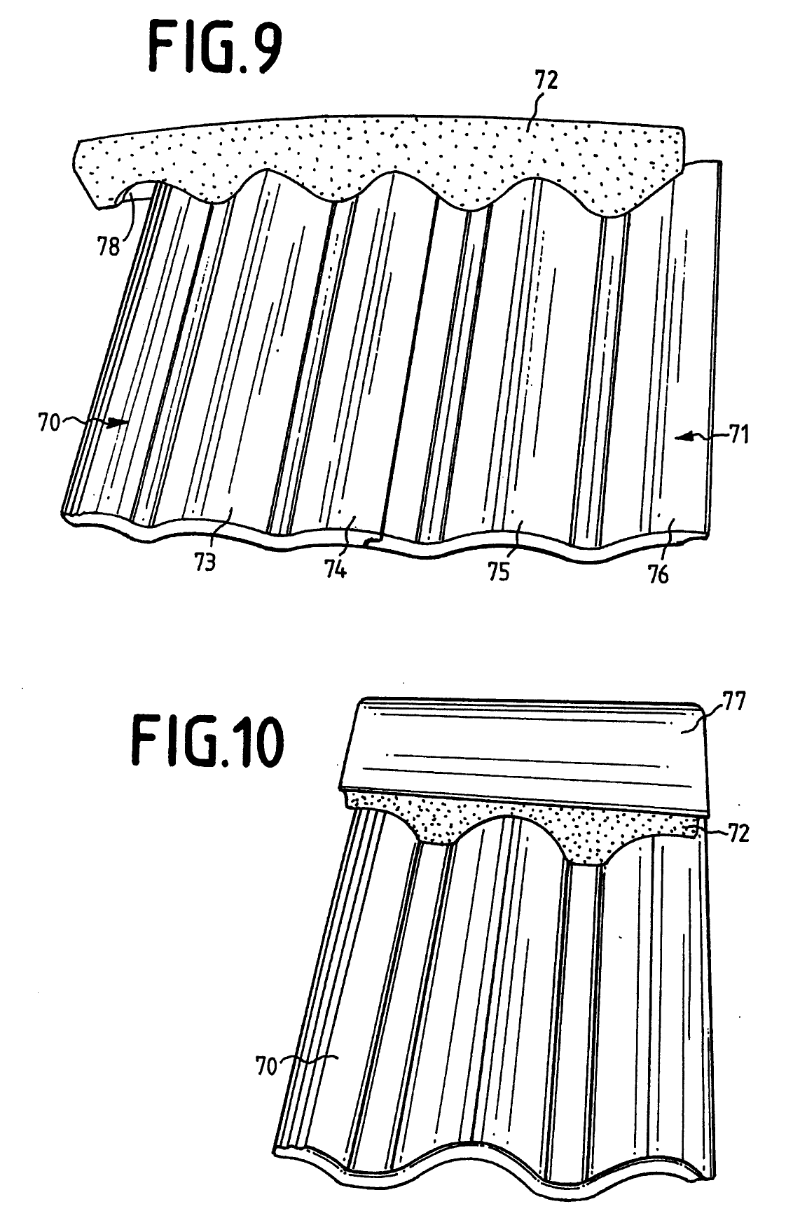

FIG. 9 a connection material approximately adapted to the outer shape of roofing tiles,

FIG. 10 the connection material according to FIG. 9, however with the ridge tile emplaced.

FIG. 1 shows a segment of a roof ridge 1, in which two roof rafters 2, 3, four roof battens 4 to 7, two roofing tiles 8, 9 and one ridge tile 10 are evident. The connection between the roofing tiles 8, 9 and the ridge tile 10 is formed by means of porous foamed material components 11, 12, which, in the final state, are rigid and solid. These foamed material components 11, 12 were deformable before they were mounted and impregnated with a dispersion binder, a linseed oil paste or the like as well as packaged in an airtight container, for example in a plastic bag. After this plastic bag is opened, the moist foamed material components 11, 12 are placed onto the roofing tiles 8, 9 and covered with the ridge tile 10. After a predetermined time the dispersion binder or the linseed oil paste is cured through and forms an adhesive connection between the ridge tile 10 and the roofing tiles 8, 9. Since the foamed material components 11, 12 are hard but still porous, the air can flow through these foamed material components 11, 12 between ridge tile 10 and roofing tiles 8, 9.

The dispersion binder is pasty, sticky and viscous. The stickiness is necessary in order for the components or elements, after they have been laid out on the oblique roof surface, to retain their adhesion in the intended position and to not slide down. The dispersion binder must in addition remain adhered in the filter foam structure on the connection webs and must not, for example during storage in a package, run off and become detached from the cell webs.

The fact that the hard foamed material components are still porous is due to the following: in the formation the filter foam is initially filled completely with the dispersion binder. The dispersion binder is subsequently squeezed out down to the necessary minimum quantity, so that the viscous and sticky composition now only still adheres on the webs of the filter foam structure, where it can no longer become detached due to its consistency and stickiness. In this way the voids for the aeration are already developed during the formation. To attain a better adhesion with the roofing and ridge systems, the foam is squeezed out such that in the outer region more of the composition remains. The ensheathing of the webs is cured after they have been laid out. Due to the curing, roofing and ridge tiles become adhered to one another, the soft foamed substance becomes a hard substance and offers protection against weathering effects.

Before they are installed, the foamed material components 11, 12 can be packaged airtight in the compressed or noncompressed state. When the airtight packaging is removed, the foamed material components 11, 12 expand by approximately an 8-fold if they had been compressed previously. The advantage of compressed foamed material components lies therein that they require less space.

Instead of a foamed material, which initially is pressed and which mechanically expands after the packaging has been removed, it would also be possible to utilize a foamed material, which expands due to chemical reactions when exposed to air.

FIG. 2 shows the same roof ridge as FIG. 1, however in front view. It is evident that there is a hollow space 13 between the two foamed material components 11, 12. The hollow space 13 would not be sufficient for the ventilation of the roof ridge if the sole air access were from the ridge ends. Rather, ventilation must additionally occur via the foamed material components.

In FIG. 3 a variant of the roof ridge 1 is shown, in which a single-piece foamed material component 20 is utilized.

In contrast to the foamed material components 11, 12, the foamed material component 20 comprises at its contact faces with the roofing tiles 8, 9 and the ridge tile 10 special adhesion layers 21 to 24. The foamed material component 20 has a curved U-shape, with the two outer shanks 25, 26 strongly thickened and the web 27 connecting them relatively thin. To prevent the water from entering from above, this web 27 can be provided on its top side with a waterproof layer 28.

Through the foamed material component 20 air 29 can enter relatively unhindered, while driven-up water and drift snow 30 are broken by the many successively disposed cell webs of the foamed material component 20 and cannot penetrate through it.

In FIG. 4 the foamed material component 20 is shown before it is installed. It can be seen that the foamed material component has now approximately the shape of an H.

FIG. 5 shows the same foamed material component 20 as FIG. 4, however, shortly after it has been removed from its airtight wrapping. This representation shows that the foamed material component 20 is significantly more compressed than in FIG. 4, and specifically at the outer shanks 25, 26 by approximately an eight-fold.

A further foamed material component 40 is shown in cross section in FIG. 6. This foamed material component is comprised of three sections 41, 42, 43, of which the two outer sections 41, 43 are developed mirror symmetrically with respect to one another and have the form of double parallelograms, with the, in each instance, outer parallelogram 44, 45 being directed downwardly and the, in each instance, inner parallelogram 46, 47 directed upwardly. The middle and third section 42 is disposed between the two outer sections 41, 43 and has the shape of a square. The connection between this section 42 and the sections 41, 43 takes place via one bridge 48, 49 each, above which is located a notch 50, 51. The middle section 42 is placed between the two upper roofing tile rows and represents a securement in place, which significantly facilitates the central alignment of the ridge elements.

In FIG. 7 the foamed material component 40 shown in FIG. 6 is depicted together with two roofing tiles 55, 56 and roof battens 57 to 60, but without a ridge tile. It can be seen that the two outer sections 41, 43 of the foamed material component can be folded downwardly and subsequently come to lie on the 6 roofing tiles 55, 56.

FIG. 8 shows the same foamed material component 40 as FIG. 7, however, with a ridge tile 61 laid in place. The foamed material component 40 here fills nearly completely the entire space between ridge tile 61 and the two roofing tiles 55, 56.

As long the foamed material component 40 is not yet cured after its installation, it closely conforms to the form of ridge tile 61 and roofing tiles 55, 56.

If the surfaces of the roofing tiles 55, 56 deviate too much from a plane, it is recommended to adapt already from the outset the foamed material component approximately geometrically to this surface. In this way it becomes possible to cover most roofing tile contours with a universal form.

FIG. 9 shows such foamed material component 72 tailored to the form of the roofing tiles 70, 71. It has sinusoidal recesses 78, which adapt only roughly to the convexities 73 to 76 of the roofing tiles 73 to 76 and which through the pressure of the ridge tile are readily and exactly adapted to different roofing tile contours.

In FIG. 10 is shown a roofing tile 70 with the foamed material component 72 depicted in FIG. 9, in which a ridge tile 77 rests on the foamed material component 72.

1. Material for forming connections between two objects (8, 10), which comprises a filter foam (11, 12) deformable in the starting state as well as a substance impregnating the filter foam (11, 12), characterized in that the substance impregnating the filter foam (11, 12) under the exclusion of air has a pasty, sticky and viscous aggregate state and, through the admission of air, assumes a solid aggregate state, and, upon assuming the solid aggregate state, connects the two objects (8, 10) with one another by adhesion and the filter foam (11, 12), after the substance is cured, remains porous, such that air can penetrate through it.

2. Material as claimed in claim 1, characterized in that the filter foam (11, 12) is comprised of polyurethane.

3. Material as claimed in claim 1, characterized in that the substance is an acrylic resin lacquer.

4. Material as claimed in claim 3, characterized in that the acrylic resin lacquer is an aqueous dispersion.

5. Material as claimed in claim 1, characterized in that in the pasty, sticky and viscous aggregate state of the substance, it is packaged airtight.

6. Material as claimed in claim 1, characterized in that the filter foam (11, 12) is compressed in the pasty, sticky and viscous aggregate state of the substance.

7. Material as claimed in claim 6, characterized in that the filter foam (11, 12) is compressible to approximately one eighth compared to its starting volume.

8. Material as claimed in claim 1, characterized in that the filter foam (20) has a U- or H-form cross sectional profile.

9. Material as claimed in claim 1, characterized in that the substance is weathering resistant.

10. Material as claimed in claim 1, characterized in that the one object is a roofing tile (8, 9) and the other object is a ridge tile (10).

11. Material as claimed in claim 1, characterized in that it is present in the form of two foamed material components (11, 12), of which the one foamed material component (11) connects a first roofing tile (8) with a ridge tile (10), while the other foamed material component (12) connects a second roofing tile (9) with the same ridge tile (10).

12. Material as claimed in claim 1, characterized in that it is present in the form of a single piece foamed material component (20), which connects a first roofing tile (8) with a ridge tile (10) and a second roofing tile (9) with the same ridge tile (10).

13. Material as claimed in claim 12, characterized in that the foamed material component (20) has substantially an H-form cross section.

14. Material as claimed in claim 13, characterized in that the side parts (25, 26) of the H-form foamed material component (20) are provided with adhesive agent layers (21 to 24) on their upper and lower side.

15. Material as claimed in claim 11, characterized in that the two foamed material components (11, 12) are of identical form.
